(19) United States
(12) Patent Application Publication
(10) Pub. No.: US 2016/0325286 A1
(43) Pub. Date: Nov. 10, 2016

(54) Method And Magazine For Holding In Readiness, Transporting, Processing And Archiving Thermoanalytical Samples

(71) Applicant: Netzsch-Geratebau GmbH, Selb (DE)

(72) Inventors: Thomas Denner, Selb (DE); Juergen Blumm, Selb (DE); Otto Max Schaefer, Selb (DE); Markus Hollering, Wunsiedel (DE); Matthias Gradl, Sesslach (DE); Gunther Herr, Haarth (DE); André Nijmeh, Merkendorf (DE); Thilo Hilpert, Selb (DE); Alexander Frenzl, Schoenwald (DE); Stefan Lauterbach, Selb (DE); Andreas Strobel, Auerbach (DE); Gabriele Kaiser, Selb (DE); Stefan Schmoelzer, Issigau (DE); Markus Meyer, Ehingen (DE); Stephan Knappe, Doehlau (DE); Rolf Preuss, Einbeck (DE); Michael Gebhardt, Selb (DE); Elena Moukhina, Selb (DE); Alexander Schindler, Leupoldsgruen (DE)

(21) Appl. No.: 15/190,777

(22) Filed: Jun. 23, 2016

Related U.S. Application Data
(63) Continuation of application No. 14/323,742, filed on Jul. 3, 2014.

(30) Foreign Application Priority Data
Jul. 5, 2013 (DE) 102013107101.5

(51) Int. Cl. B01L 9/06; G01N 35/00; G01N 25/00; B01L 3/00

(52) U.S. Cl. CPC B01L 9/06; B01L 3/5453; G01N 35/00732; G01N 25/00; B01L 2200/18; B01L 2300/021; B01L 2300/022; G01N 2035/00752

(57) ABSTRACT

A method and a device for holding in readiness, transporting, processing and archiving thermoanalytical samples are disclosed. The sample containers, into which the thermoanalytical samples to be investigated are to be introduced, are provided in a magazine.

### FIELD OF THE INVENTION

The present invention relates to a method and a magazine for holding in readiness, transporting, processing and archiving thermoanalytical samples.

### BACKGROUND OF THE INVENTION

US patent application 2013/0105677 A1 discloses a sample carrier for use with mineralogical samples in laser spectroscopy. The sample holder comprises a base plate, on which a reference sample is fixedly disposed. Furthermore, the sample holder is provided on its base with a fixed number of sample places, into which the samples to be measured can be introduced for analysis. When the samples are placed on the base of the sample holder, a cover is positioned above the samples, which is then connected firmly and detachably by a fastening element to the sample tray. Provided in the cover of the sample holder are openings through which the samples can be measured. For the measurement itself, the sample carrier is rotated and introduced with the cover down into a corresponding measuring device.

German utility model DE 20 2007 002 324 U1 discloses a device for thermoanalytical measurement with a sample magazine with a plurality of sample holders, a regulatable temperature control device, a measurement holding fixture disposed in the measurement chamber and a control and regulation unit. A particular feature of this utility model is that at least one sample holder cooperates with a regulatable temperature control device.

Devices for thermoanalytical investigation are for example calorimeters, which work according to the differential scanning principle (DSC) or according to the principle of power compensation, as well as devices for thermogravimetric, thermomechanical, dynamically mechanical or electrical analysis (TGA, TMA, DMA or DEA). These devices can be operated both with individual samples and also in combination with a sample magazine with a plurality of sample holders. Sample magazines are used in particular in round or square form for the measurement of a plurality of samples or for automated measurement. The apparatuses and devices that are used for thermoanalytical measurements and investigations and the scientific principles and methods upon which they are based are in principle known from the prior art and will not be dealt with further here.

### SUMMARY OF THE INVENTION

The problem underlying the invention is to provide a method for the economical and operationally reliable provision, analysis and archiving of thermoanalytical samples.

The above problem is solved by a method for holding in readiness, transporting, processing and archiving thermoanalytical samples. Further advantageous features can be found in the sub-claims.

Furthermore, the problem underlying the invention is to provide a magazine, with which samples for thermoanalytical investigation can be made available, analysed and archived economically in an operationally reliable manner.

The above problem is solved by a magazine for holding in readiness, transporting, processing and archiving thermoanalytical samples. Further advantageous features can be found in the sub-claims.

A method for holding in readiness, transporting, processing and archiving thermoanalytical samples is disclosed. The sample containers, into which the thermoanalytical samples to be investigated are to be introduced, are provided in a magazine. For the loading of the sample containers with corresponding sample material, the sample containers are removed from the magazine. A sample is then put into each sample container. The data of the thermoanalytical samples to be investigated are entered in an electronic and/or an analog data list for the magazine. A fixed place in the magazine is assigned to each sample container which is filled with a sample. For transport, the magazine is firmly closed with a transport securing means. In a preferred embodiment, the transport securing means is a cover, which can be connected firmly, but detachably to the magazine. For the further processing or for the analysis of the sample, the re-opened magazine is introduced into a measuring device for thermal analysis. After the introduction of the magazine into the measuring device, the magazine is identified by detection means. In the identification, the data from the data list of the magazine are read out with the detection means, the position of each sample container at the same time being transmitted to the measuring device. Each sample together with the sample container is then automatically removed from the magazine and transferred for the given measurement. After completion of the measurement, each sample together with the respective sample container is then automatically transferred back again into the magazine. After completion of all the measurements, the samples including the sample containers are archived together with the magazine.

It is clear to a person skilled in the art in the area of thermal analysis that the samples, or the sample containers, can also be removed manually by the operator from the magazine and transferred for the measurement. After completion of the measurement, the samples, or the sample containers, would be sorted into the magazine manually by the operator.

The magazine is at all events unequivocally identifiable, the identification being carried out by a detection means. The actual identification of the magazine can be carried out automatically by a detection means on the measuring device or manually by the user. RFID chips, 2D-codes, barcodes or text boxes can be read out with the detection means. For an accurate identification, it is necessary for the operator either to download the data of the respective samples via a data-processing system, for example on the RFID chip, or to make the data accessible via a database for the read-out of the barcode. In the case where use is made of the text boxes described above, it concerns a folded book which is appended to the outer packaging of the magazine. This folded book contains lines and columns, in which the precise data of each sample can be entered in respect of each sample container.

Before the first use, i.e. after delivery of the magazine, an empty sample container with an associated cover is present on each position. In a preferred embodiment, each sample container and each cover have been pre-weighed before the magazine is loaded and the data of the respective sample container and its associated cover have been detected and can be read out via the detection means of the measuring device. In further embodiments, various positions of the magazine can remain empty. Furthermore, it is possible that only one sample container or only one cover is present at a position. It is also possible for a sample container and a cover to be disposed in pairs beside one another in each case. For the loading with the sample, the sample container can be removed from the magazine and inserted again. The associated cover is then positioned on the sample container. This has the advantage that the very thin cover with a tendency towards deformation does not have to be moved unnecessarily frequently.

Furthermore, a magazine for holding in readiness, transporting, processing and archiving thermoanalytical samples is disclosed. The magazine has a predetermined grid, as a result of which the position of each sample container, including its cover, is known. In addition, the magazine comprises a transport securing means, with which the magazine can be firmly closed for transport and/or for archiving. Fitted on an end face of the magazine is a detection means, by means of which the magazine is unequivocally identifiable. The magazine is provided with an outer packaging, wherein this outer packaging is assigned unequivocally to the magazine. This unequivocal assignment of the outer packaging to the given associated magazine is very important for use as an archiving means. As a result of the fixed link between the magazine and the outer packaging, it is possible in the archive to ascertain just from the exterior which magazine or which samples are present in the given outer packaging. The outer packaging is provided with a data list for the sample data. This data list is generally constituted as a folded book or as an RFID chip. The folded book present on the outer packaging is also known to the person skilled in the art as a Leporello. The data of the samples can be entered in this folded book, the folded book always being firmly attached to the outer packaging.

The magazine is connected detachably to the outer packaging, wherein the detachable connection between magazine and outer packaging is constituted as a plug-in system or as a glued joint. In the case of the use of a plug-in system, the magazine is pushed into the outer packaging. The magazine is firmly located in position in the outer packaging by means of webs which are located above the magazine and above the transport securing means.

For the person skilled in the art, it is also possible to fix the magazine in the outer packaging by means of adhesive dots. After use of the magazine in a measuring device, it is subsequently also possible to firmly glue the magazine again in the outer packaging. Many devices and methods are known from the prior art with which magazines can be fixed detachably in an outer packaging. The two previously described possibilities do not therefore represent a limitation of the scope of protection.

Examples of embodiment of the invention and its advantages will be explained in greater detail below with the aid of the appended figures. The size ratios of the individual elements with respect to one another in the figures do not always correspond to the actual size ratios, since some forms are represented simplified and other forms are represented enlarged in relation to other elements for the sake of better illustration.

### BRIEF DESCRIPTION OF THE DRAWINGS

FIG. 1 shows a measuring device for thermoanalytical investigations.

FIG. 2 shows a magazine according to the invention.

FIG. 3 shows a sample container with a cover, as is present in the magazine according to the invention.

FIG. 4 shows an outer packaging with an associated magazine according to the invention.

### DETAILED DESCRIPTION OF THE INVENTION

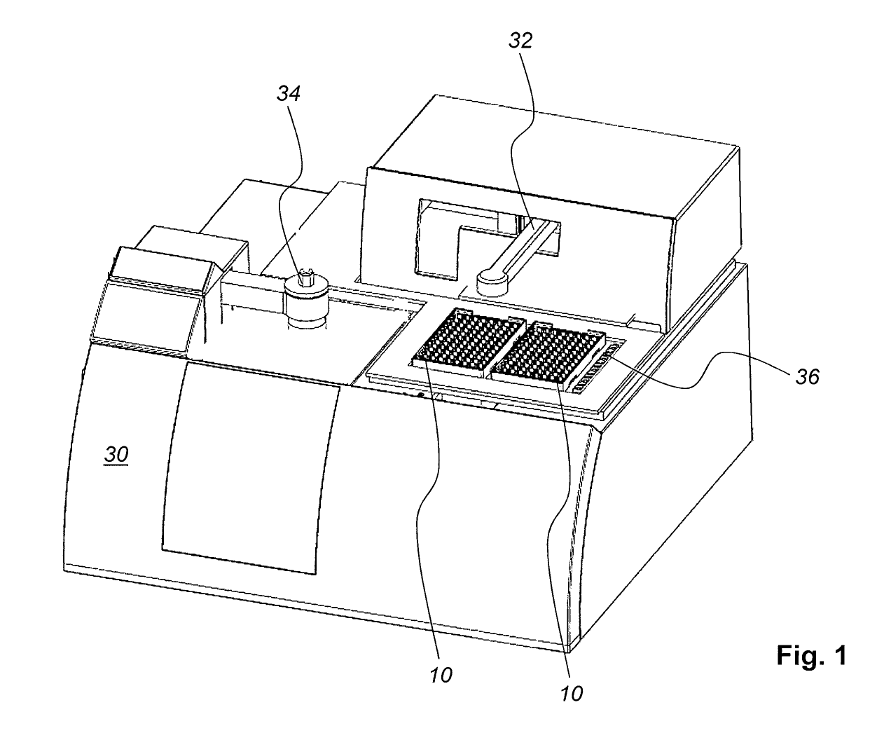

FIG. 1 shows an arbitrary measuring device 30 for thermoanalytical investigations. Measuring device 30 is provided with a magazine tray 36, on which two magazines 10 are disposed in the shown embodiment. Magazines 10 are unequivocally identifiable with detection means. With detection means, it is possible to read out the data from the data list of the magazine (not represented) and to transmit the latter to measuring device 30. By means of removal device 32, individual samples or sample containers (not represented) can be removed from one of magazines 10 and introduced into measurement chamber 34. After completion of the measurement, the samples or sample containers are again removed with removal device 32 out of sample chamber 34 and transferred to respective magazine 10. It is always the case here that the corresponding sample container is placed back onto the given position which it had occupied previously in the given magazine 10.

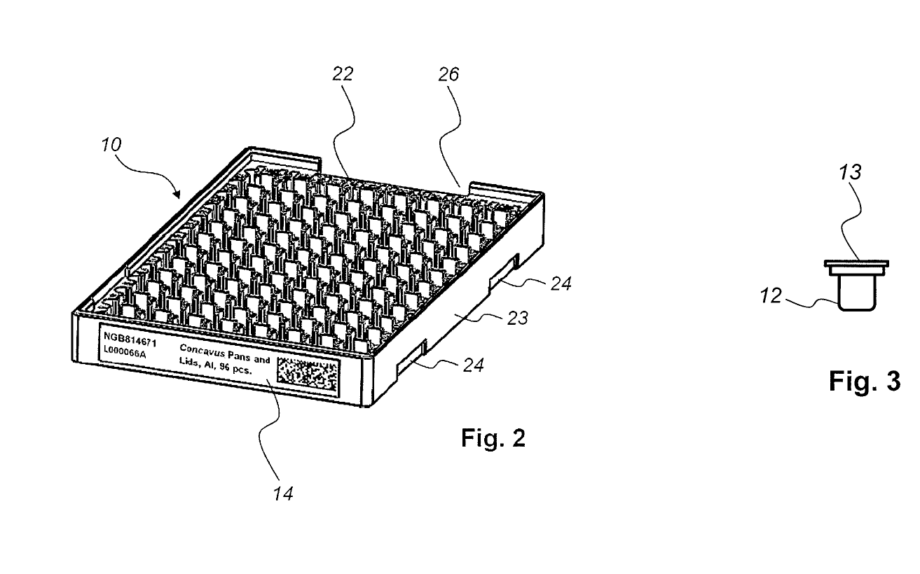

FIG. 2 shows a magazine 10 according to the invention, which is provided with a plurality of mounts 22 for sample containers (not represented). A data list 14 for respective magazine 10 can be seen on the front side. Magazine 10 is unequivocally identifiable by this data list 14. A recess 26 for the transport securing means (not represented) is introduced on the side lying opposite data list 14. The transport securing means is subsequently introduced into this recess 26. Locking devices 24 are provided on longitudinal sides 23 of magazine 10. Magazine 10 can be positioned in a measuring device or fixed in an outer packaging (not represented) by means of these locking devices 24.

FIG. 3 shows a sample container 12 with a cover 13, such as can be introduced into magazine 10 according to the invention. This sample container 12 and associated cover 13 are pre-weighed before the loading of magazine 10 in production and are then assigned to a fixed position in magazine 10. The data of each sample container 12 and of associated cover 13 are stored in data list 14 for magazine 10.

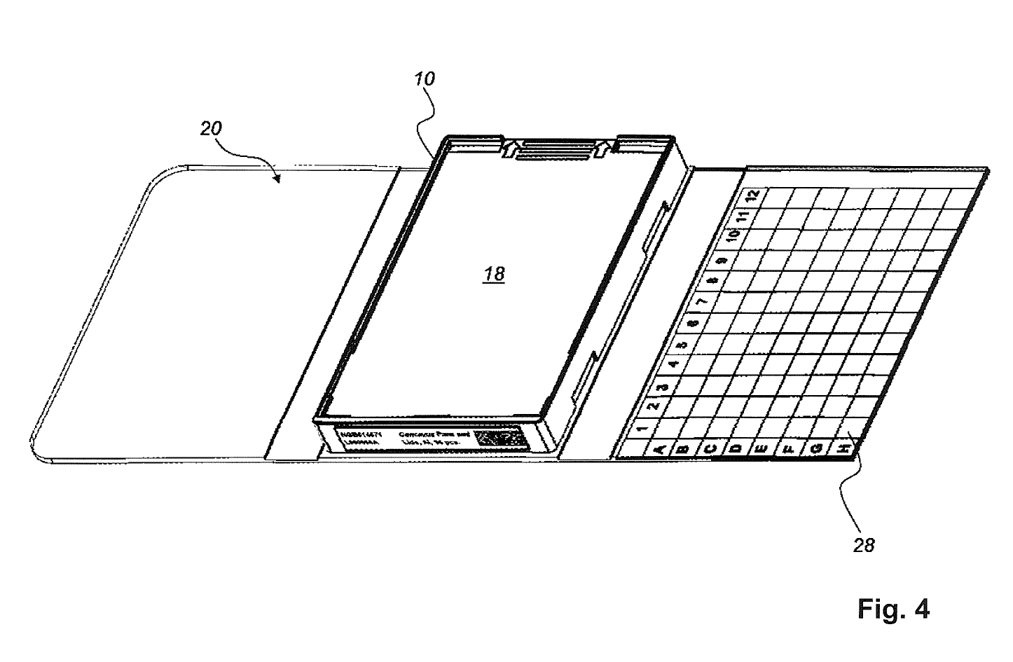

FIG. 4 shows an outer packaging 20 with its associated magazine 10. Furthermore, outer packaging 20 is provided with data list 28 of outer packaging 20. The data of the individual samples and a precise identification of the respective samples that are present in associated magazine 10 can be entered in this data list 28.

The invention has been described by reference to a preferred embodiment. For a person skilled in the art, however, it is conceivable for modifications or changes to be made to the invention without thereby departing from the scope of protection of the following claims.

1-6. (canceled)

7. A magazine for holding in readiness, transporting, processing, and archiving thermoanalytical samples, wherein the positions of each sample holder in the magazine are known, wherein the magazine comprises a transport securing means and wherein the magazine comprises a detection means, wherein the magazine comprises an outer packaging, wherein the outer packaging is unequivocally assignable to the magazine.

8. The magazine of claim 7, wherein the outer packaging is provided with a data list of the outer packaging for sample data.

9. The magazine of claim 8, wherein the data list is a folded book, a 2D-code, a barcode or an RFID chip.

10. The magazine of claim 7, wherein the magazine is connected detachably to the outer packaging.

11. The magazine of claim 7, wherein the detachable connection between the magazine and the outer packaging is constituted as a plug-in system or as a glued joint.

12. The magazine of claim 8, wherein the magazine is connected detachably to the outer packaging.

13. A sample magazine, comprising:
a body having a plurality of mounts, each of the plurality of mounts configured to receive a respective sample container;
a cover detachably connected to the body, the cover moveable relative to the body between a closed position, in which the plurality of mounts are covered by the cover, and an open position, in which the plurality of mounts are exposed to an ambient environment;
a first identifier disposed relative to the body, the first identifier configured to permit unequivocal identification of the sample magazine.

14. The sample magazine of claim 13, wherein the first identifier includes a data list that includes electronic data and/or analog data.

15. The sample magazine of claim 13, wherein the first identifier includes a data list in the form of at least one of a folded book, a 2D-code, a barcode, and an RFID chip.

16. The sample magazine of claim 13, further comprising outer packaging detachably connected to the body.

17. The sample magazine of claim 16, wherein the outer packaging includes a second identifier, the second identifier including data regarding the respective sample containers that each of the plurality of mounts are configured to receive, and/or data regarding respective samples disposed within the sample containers.

18. A system, comprising:
a sample magazine including:
a body having a plurality of mounts, each of the plurality of mounts configured to receive a respective sample container;
a cover detachably connected to the body, the cover moveable relative to the body between a closed position, in which the plurality of mounts are covered by the cover, and an open position, in which the plurality of mounts are exposed to an ambient environment; and
an identifier disposed on the body and configured to permit unequivocal identification of the sample magazine; and
a measuring device configured to receive the sample magazine, the measuring device including a detector configured to read the identifier to unequivocally identify the sample magazine.
